(19) United States
(12) Patent Application Publication
(10) Pub. No.: US 2014/0151588 A1
(43) Pub. Date: Jun. 5, 2014

(54) ADJUSTABLE GAS ELECTROMAGNETIC VALVE

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); KUAN-CHOU LIN, Taichung (TW); YEN-JEN YEH, Yunlin (TW)

(73) Assignee: GRAND MATE CO., LTD., Taichung (TW)

(21) Appl. No.: 13/777,249

(22) Filed: Feb. 26, 2013

(30) Foreign Application Priority Data
Dec. 3, 2012 (TW) 101145302

(51) Int. Cl. F16K 31/06

(52) U.S. Cl. CPC F16K 31/0675
USPC 251/129.01

(57) ABSTRACT

An adjustable gas electromagnetic valve includes a valve body having an inlet, an outlet, and two gas passage, which are a first gas passageway and a second gas passageway between the inlet and the outlet. In the first gas passageway, a gate member and an actuator are provided. The actuator is activated by electrical signals to move the gate member so as to open or close the first gas passageway. As a result, a gas flow provided by the gas electromagnetic valve is adjustable by controlling the actuator.

### BACKGROUND OF THE INVENTION

1. Field of the Invention

The present invention relates generally to a gas stove, and more particularly to a gas fireplace with an adjustable gas electromagnetic valve.

2. Description of the Related Art

In a conventional gas stove, a gas regulator, such as proportional valve, stepper motor valve, and DC motor valve, is provided to adjust the gas flow for the burner. The conventional gas regulator is provided with a gate, which is movable under control, to change a size of a passageway in the valve. It is easy to understand that the size of the passageway is proportional to the gas flow. In comparison with a solenoid valve, the conventional gas regulator is bigger, more complex, and needs higher power. However, the solenoid valve is able to open and close the passageway only, and it can't partially open the passageway. That is why the solenoid valve is never used to control the gas flow.

### SUMMARY OF THE INVENTION

The primary objective of the present invention is to provide an adjustable gas electromagnetic valve, which has a simple structure and is able to control a gas flow.

According to the objective of the present invention, the present invention provides an adjustable gas electromagnetic valve, including a valve body, a gate member, and an actuator. The valve body has an inlet, an outlet, a first gas passageway, and a second gas passageway, wherein gas enters the valve member via the inlet and leaves via the outlet, and the first passageway and the second gas passageway respectively connect the inlet to the outlet. The gate member is received in the first gas passageway to be moved between a first position, in which the gate member keeps the first gas passageway open, and a second position, in which the gate member keeps the first gas passageway closed. The actuator is activated by electrical signals to move the gate member.

Therefore, the adjustable gas electromagnetic valve is controllable by electrical signals to adjust the gas flow.

### BRIEF DESCRIPTION OF THE DRAWINGS

FIG. 1 is a perspective view of a preferred embodiment of the present invention;

FIG. 2 is an exploded view in part of the preferred embodiment of the present invention;

FIG. 3 is a sectional view along the A-A′ line of FIG. 1, showing the first gas passageway and the second gas passageway;

FIG. 4 is a sectional view along the A-A′ line of FIG. 1, showing the opened first gas passageway; and

FIG. 5 is a sectional view along the A-A′ line of FIG. 1, showing the closed first gas passageway.

### DETAILED DESCRIPTION OF THE INVENTION

The detailed description and technical contents of the present invention will be explained with reference to the accompanying drawings. However, the drawings are illustrative only but not used to limit the present invention.

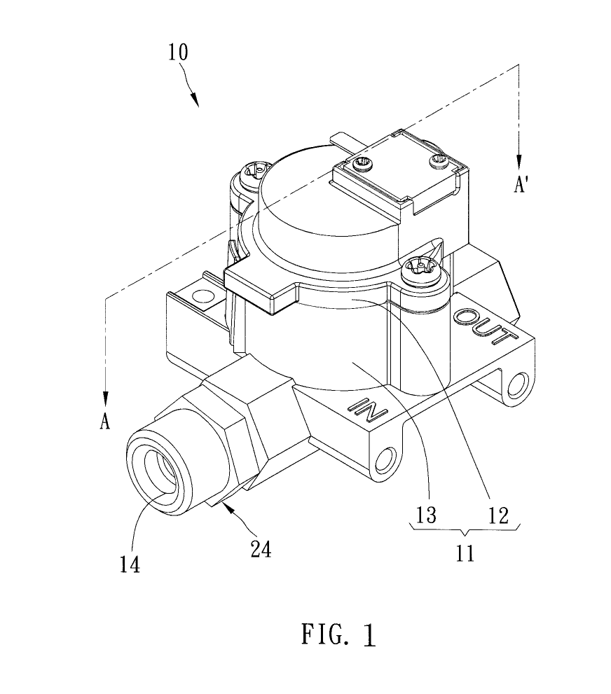

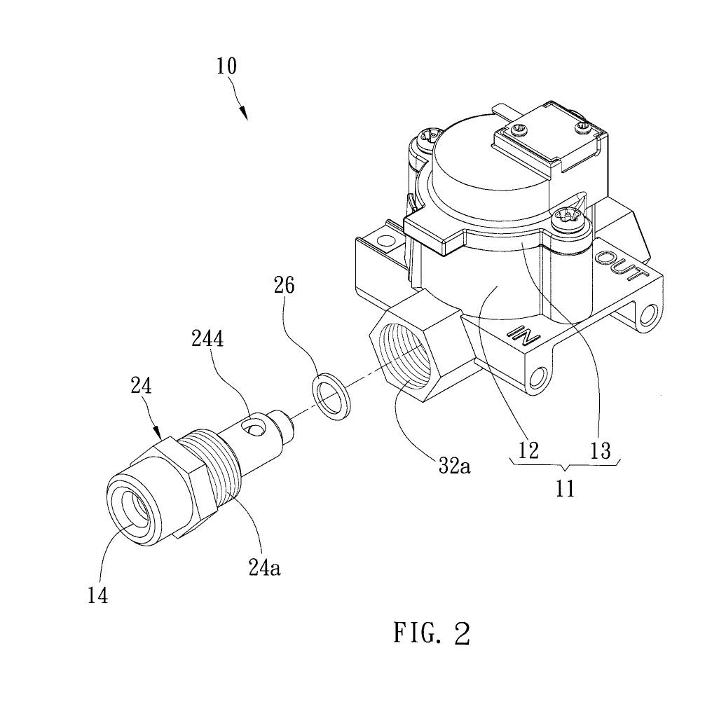

As shown in FIG. 1 to FIG. 5, an adjustable gas electromagnetic valve of the preferred embodiment of the present invention, which is mounted on a gas pipe, includes a valve body 10, a gate member 28, and an electromagnetic actuator 30.

The valve body 10 has an inlet 14, an outlet 15, a first gas passageway 16, and a second gas passageway 18. Gas enters the valve member 10 via the inlet 14 and leaves via the outlet 15. Two ends of the first and the second gas passageways 16, 18 respectively connect the inlet 14 and the outlet 15. In an embodiment, the valve body 10 further has a main body 11, a first regulator 22, and a second regulator 24.

The main body 11 has a cover 12 and a base 13. The cover 12 is engaged with the base 13 to form a chamber 11a therebetween. The cover 12 has a connecting tunnel 122, which has an end communicated with the chamber 11a. A thread 122a is provided on a sidewall of the connecting tunnel 122.

The base 13 has a main tunnel 132, a first tunnel 134, and a second tunnel 134. The main tunnel 132 extends through the base 13, and an end of the main tunnel 132 is the outlet 15. A thread 132a is provided on a sidewall of the main tunnel 132 adjacent to an end opposite to the outlet 15. The first tunnel 134 connects the main tunnel 132 and the chamber 11a, and the second tunnel 136 connects the connecting tunnel 122 and the main tunnel 132.

The first regulator 22 is received in the chamber 11a and has a thread 22a to be meshed with the thread 122a in the connecting tunnel 122. The first regulator 22 has a first through hole 221 to form a part of the first gas passageway 16. The first regulator 22 in the chamber 11a has an air inlet 222 at an end of the first through hole 221.

The second regulator 24 has a thread 24a to be meshed with the thread 132a in the main tunnel 132. The second regulator 24 has a second through hole 242 and a side bore 244. The second through hole 242 extends through the second regulator 24, and the inlet 14 is at a distal end of the second through hole 242. The second through hole 242 has a small section 242a and a large section 242b, wherein a cross section of the large section 242b is greater than the small section 242a. The inlet 14 is formed at a distal end of the large section 242b, and the small section 242a is connected to the other end of the large section 242a and then connected to the main tunnel 132 of the base 13. The side bore 244 connects the large section 242b of the second through hole 241 to the first tunnel 134.

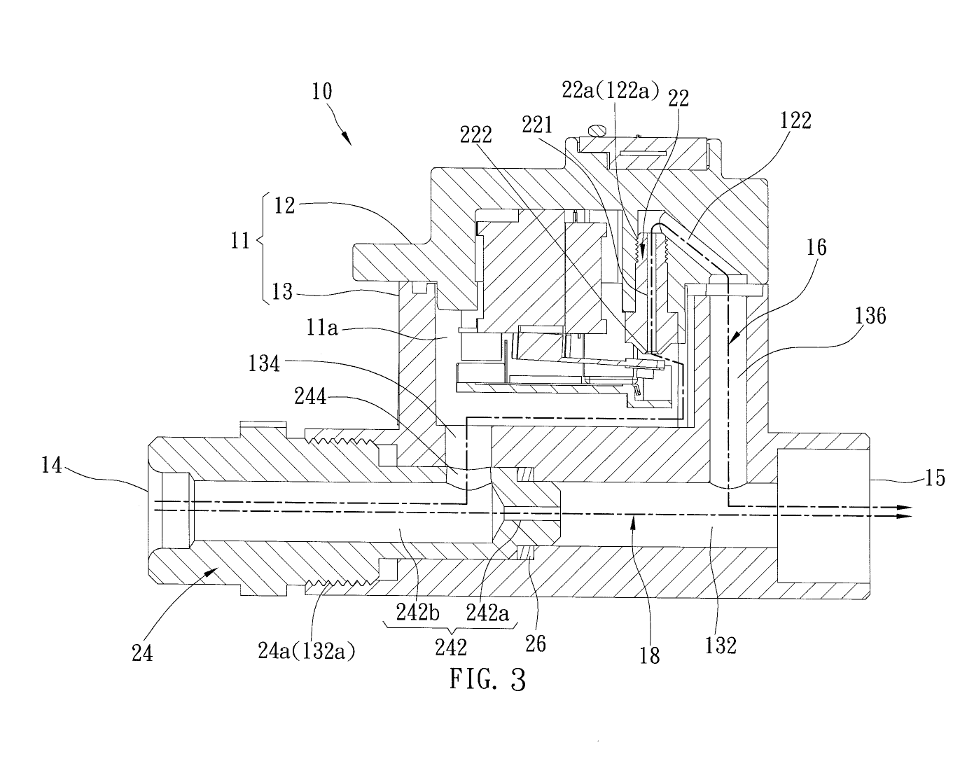

As shown in FIG. 3, the first gas passageway 16 starts from the inlet 14, and sequentially goes through the large section 242b of the second through hole 241, the side bore 244, the first tunnel 134, the chamber 11a, the first through hole 221 of the first regulator 22, the connecting tunnel 122, the second tunnel 136, and the main tunnel 132, and finally arrives the outlet 15. The second gas passageway 18 directly extends from the inlet 14 to the outlet 15 through the second through hole 242 and the main tunnel 132 in sequence.

Cross sections of the first through hole 221 of the first regulator 22 and the small section 242a of the second through hole 242 of the second regulator 24 are adjustable, so that the gas flows through the first passageway 16 and the second passageway 18 are controllable by operating the first regulator 22 and the second regulator 24.

In an embodiment, the first regulator 22 and the second regulator 24 are screwed into the main body 11 so that the first passageway 16 and the second passageway 18 are adjustable by switching the regulators 16, 18 of different sizes. An sealing member, which is an O-ring 26 in the embodiment, is provided between the base 13 and the second regulator 24 to prevent gas leaks, so that the gas flow enters the second regulator 24 will be divided into two gas flows in the large section 242b, one goes to the small section 242a (the first passageway 18), and the other goes to the side bore 244 (the second passageway 16). In an embodiment, the first and the second regulators are inherently made valve body 10, which means the first and the second passageways 16, 18 are unadjustable in such a case.

The gate member 28 and the electromagnetic actuator 30 are received in the chamber 11a, and the gate member 28 is connected to the electromagnetic actuator 30. The electromagnetic actuator 30 is a solenoid valve and is activated by an electrical signal to move the gate member 28 between a first position P1 and a second position P2.

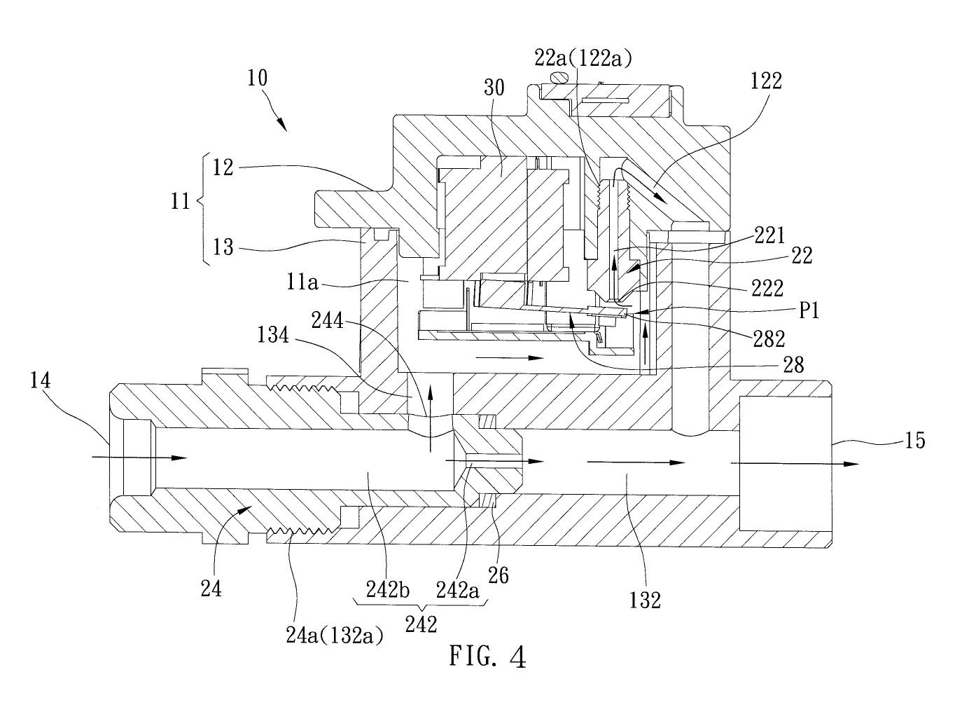

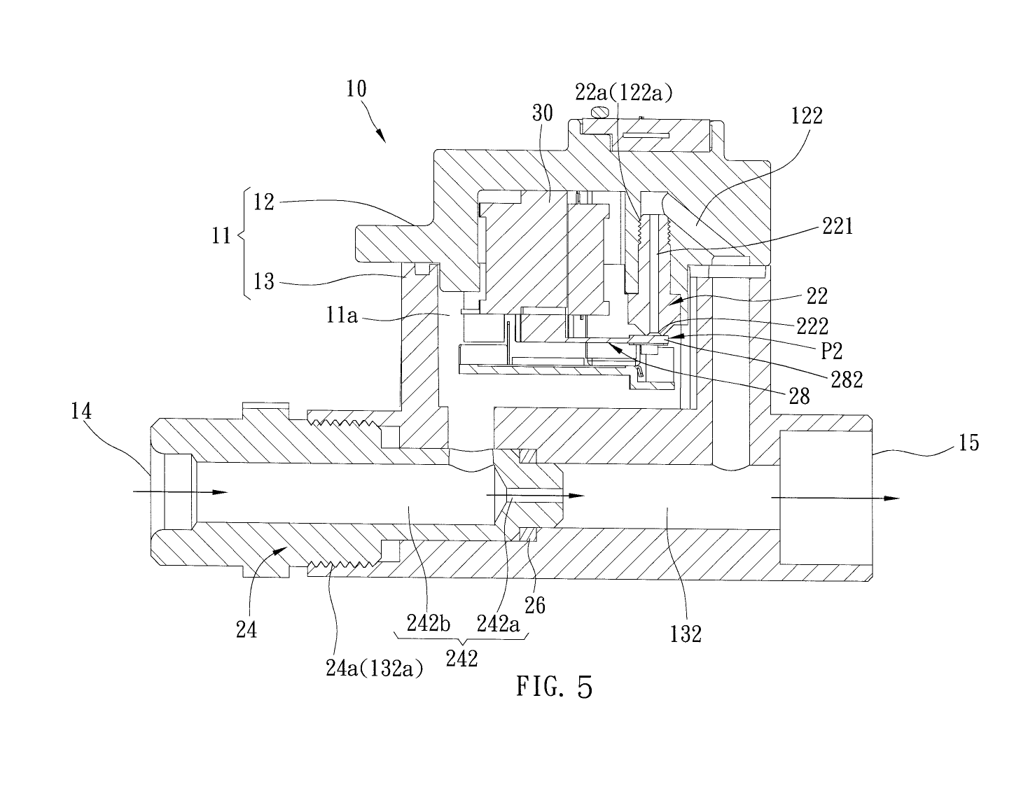

In the first position P1, the gate member 28 is attached to the first regulator 22 to seal the first through hole 222, and in the second position P2 the gate member 28 is kept away from the first regulator 22. In other words, the electromagnetic actuator 30 is subject to open or close the first gas passageway 16, therefore the gas flow out of the outlet 15 is a sum of the gas flows in the first and the second passageways 16, 18 when one inputs a command for the electromagnetic actuator 30 to open the first gas passageway 16 (FIG. 4), and the gas flow out of the outlet 15 is equal to the gas flow in the second passageway 18 when one inputs a command for the electromagnetic actuator 30 to close the first gas passageway 16 (FIG. 5).

With the design of above, the electromagnetic actuator 30 is made into the gas electromagnetic valve of the present invention to control the gas flow.

The gas electromagnetic valve of the present invention is connected to a gas pipe of a stove so that the gas flow for the stove is controllable by controlling the electromagnetic actuator 30. It is noted that the gas electromagnetic valve of the present invention will provide gas flow to the stove all the time to keep it burning.

In comparison with the conventional gas regulator, the gas electromagnetic valve of the present invention has a simple structure, a small size, and a fast reaction. It needs power only when the electromagnetic actuator 30 is activated, so the power consumption is lower.

It is easy to understand that it can provide another gate member and another electromagnetic actuator in the second gas passageway, so that it is able to open and close the second passageway by controlling the electromagnetic actuator as well. As a result, there will be four kinds of gas flows out of the outlet, including 1) none: both the first and the second passageways are closed; 2) small gas flow: the first passageway is closed and the second passageway is opened; 3) large gas flow: the first passageway is opened and the second passageway is closed; and 4) maximum gas flow: both the first and the second passageways are opened.

In an embodiment, the valve body is provided with three gas passageways, a first passageway, a second passageway, and a third passageway, respectively connect the inlet and the outlet. Two or more gate members and actuators are provided in the passageways respectively to achieve the same function.

The description above is a few preferred embodiments of the present invention, and the equivalence of the present invention is still in the scope of claim construction of the present invention.

1. An adjustable gas electromagnetic valve, comprising:
a valve body having an inlet, an outlet, a first gas passageway, and a second gas passageway, wherein gas enters the valve body via the inlet and leaves via the outlet, and two ends of the first passageway and the second gas passageway respectively connect the inlet and the outlet;
a gate member received in the first gas passageway to be moved between a first position, in which the gate member keeps the first gas passageway open, and a second position, in which the gate member keeps the first gas passageway closed; and
an actuator connected to the gate member, wherein the actuator is activated by electrical signals to move the gate member;
wherein the valve body has a chamber therein, the chamber forms a part of the first gas passageway and the chamber is wider than the rest part of the first gas passageway, and the actuator is received in the chamber;
wherein the second gas passageway is straight from the inlet to the outlet, and the actuator is not received in the second gas passageway.

2. The adjustable gas electromagnetic valve as defined in claim 1, wherein the first gas passageway is longer than the second passageway.

3. (canceled)

4. The adjustable gas electromagnetic valve as defined in claim 1, wherein the valve body further has a first regulator, which is connected to the main body; the first regulator has a through hole to form a part of the first gas passageway, and the gate member is attached to an end of the first regulator in the second position to close the first gas passageway and is kept away from the first regulator in the first position to open the first gas passageway.

5. The adjustable gas electromagnetic valve as defined in claim 4, wherein the first regulator has an end inserted into the first gas passageway and an opposite end in the chamber.

6. The adjustable gas electromagnetic valve as defined in claim 1, wherein the valve body further has a second regulator, which is connected to the main body; the second regulator has a through hole to form a part of the second gas passageway and a side bore to form a part of the first passageway.

7. The adjustable gas electromagnetic valve as defined in claim 6, further comprising a sealing member between the second regulator and the main body.

8. (canceled)

9. (canceled)
